(19) United States
(12) Patent Application Publication
(10) Pub. No.: US 2025/0283775 A1
(43) Pub. Date: Sep. 11, 2025

(54) HUGE FLEET SEA WATER INJECTION PUMP'S MECHANICAL SEAL INTEGRITY TESTING PORTABLE RIG

(71) Applicant: SAUDI ARABIAN OIL COMPANY, Dhahran (SA)

(72) Inventors: Salimkumar Pathrose Thresial, Udhailiyah (SA); Nasser Y Alospi, Al Hofuf (SA); Abdullah S. Bahlas, Al Khobar (SA); Abdulaziz A. Bakheet, Al Mubarraz (SA); Mohammed E. Alofie, Al Hofuf (SA)

(73) Assignee: SAUDI ARABIAN OIL COMPANY, Dhahran (SA)

(21) Appl. No.: 18/597,247

(22) Filed: Mar. 6, 2024

(51) Int. Cl. G01M 3/28; F04B 47/04; F04B 51/00

(52) U.S. Cl. CPC G01M 3/2869; F04B 51/00; F04B 47/04; F04B 2201/0803

(57) ABSTRACT

A system for pumping a fluid into a sub-surface formation to pressurize the sub-surface formation using a pump having a shaft. The system includes a mechanical seal removably installed in the pump and a mechanical seal integrity testing rig configured to be pressed against the mechanical seal and to test an integrity of the mechanical seal. The mechanical seal removably installed in the pump comprises a mechanical seal sleeve delineating a conduit configured to receive the shaft of the pump and a bottom end and a mechanical seal flange. The system further includes a mechanical seal integrity testing rig configured to be pressed against the mechanical seal and to test an integrity of the mechanical seal. The mechanical seal integrity testing rig comprises a testing rig sleeve having a top end of testing rig sleeve and a bottom end of testing rig sleeve and a mechanical seal sleeve blind.

### BACKGROUND

Wells are drilled into the surface of the Earth to access and produce hydrocarbons. The process of building a well is often split into two parts: drilling and completion. Drilling a well may include using a drilling rig to drill a hole into the ground, trip in at least one string of casing, and cement the casing string in place. Once the production zone is drilled, well completion is performed, surface facilities are connected, and production is initiated. To maintain or increase production, an injection well may be drilled and then utilized to introduce fluids into a wellbore. Fluids that are utilized in well injection may include water, gas and chemicals. Water injection is primarily used to preserve well pressure and to displace hydrocarbons. Gas injection, such as carbon dioxide injection, may be utilized to increase hydrocarbons displacement. Chemical injection may be used for tasks such as corrosion inhibition.

An injection well may include an injection pump to increase the pressure of the injection fluid. Additionally, fluids with low mobility may require an injection pump to inject to meet injection rate requirements. One of the main components of an injection pump is a shaft pump which has a torsional motion that causes a fluid to be drawn in, pressurized, and then discharged. To avoid fluid leakage along the shaft, seals may be installed around the shaft. The seals may be tested before installation to evaluate their integrity and ensure that they can withstand operational conditions without failure. Currently there are no mechanical seal integrity testing rigs for machinal seals of large injection pumps that have pump shafts larger than 8.” Therefore, mechanical seals are installed without a quality check which may result in operational inefficiency.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to systems for pumping a fluid into a sub-surface formation to pressurize the sub-surface formation using a pump having a shaft. In one or more embodiments, the system includes a mechanical seal removably installed in the pump that comprises a mechanical seal sleeve delincating a conduit configured to receive the shaft of the pump and comprising a top end and a bottom end and a mechanical seal flange. The mechanical seal flange comprises a first lateral end and a second lateral end. The mechanical seal removably installed in the pump further comprises a mechanical seal integrity testing rig configured to be pressed against the mechanical seal and to test an integrity of the mechanical seal. In one or more embodiments, the mechanical seal integrity testing rig comprises a testing rig sleeve having a top end of testing rig sleeve and a bottom end of testing rig sleeve, wherein the testing rig sleeve is pressed against the first lateral end and the second lateral end. Additionally, the mechanical seal integrity testing rig may further comprise a mechanical seal sleeve blind pressed against the top end of the mechanical seal sleeve.

This disclosure presents, in accordance with one or more embodiments, a method for testing an integrity of a mechanical seal using a mechanical seal integrity testing rig. In one or more embodiments, the method comprises connecting a pressure control and relief system to a mechanical seal integrity testing rig, the pressure control and relief system including a first valve and a second valve and connecting the mechanical seal integrity testing rig to a mechanical seal. In one or more embodiments, connecting the mechanical seal integrity testing rig to a mechanical seal comprises pressing a testing rig sleeve against a mechanical seal flange, wherein the mechanical seal flange comprises a first lateral end and a second lateral end, and pressing a testing rig seal flange against a top end of the testing rig sleeve. Additionally, connecting the mechanical seal integrity testing rig to a mechanical seal may further comprise fastening the testing rig sleeve, the testing rig seal flange and the first lateral end of the mechanical seal flange with a first outer stud bar, and pressuring a mechanical seal sleeve blind against an upper surface of top end of the mechanical seal sleeve.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 schematically illustrates, in cross-sectional elevational view, an injection well system in accordance with one or more embodiments.

FIG. 2 schematically illustrates a closeup, cross-sectional elevational view of the injection pump of FIG. 1 in accordance with one or more embodiments.

FIG. 3 schematically illustrates a closeup, cross-sectional elevational view of the mechanical seal in accordance with one or more embodiments.

FIG. 4A schematically illustrates a closeup, cross-sectional elevational view of the mechanical seal located in a mechanical seal integrity testing rig in accordance with one or more embodiments.

FIG. 4B schematically illustrates a closeup, cross-sectional elevational view of the mechanical seal located in the mechanical seal integrity testing rig, which is resting on a seal holder in accordance with one or more embodiments.

FIG. 5 schematically illustrates the mechanical seal integrity testing rig located on a test bench in accordance with one or more embodiments.

FIG. 6 shows a flowchart of a method in accordance with one or more embodiments.

FIG. 7 schematically illustrates a computing device and related components, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Regarding the figures described herein, when using the term “down” the direction is toward or at the bottom of a respective figure and “up” is toward or at the top of the respective figure. “Up” and “down” are oriented relative to a local vertical direction. However, in the oil and gas industry, one or more activities take place in a vertical, substantially vertical, deviated, substantially horizontal, or horizontal well. Therefore, one or more figures may represent an activity in deviated or horizontal wellbore configuration. “Uphole” may refer to objects, units, or processes that are positioned relatively closer to the surface entry in a wellbore than another. “Downhole” may refer to objects, units, or processes that are positioned relatively farther from the surface entry in a wellbore than another. True vertical depth is the vertical distance from a point in the well at a location of interest to a reference point on the surface.

By way of general background in accordance with one or more embodiments, after a wellbore has been drilled and cemented at a well site, surface facilities are connected and hydrocarbon production begins. To enhance hydrocarbon recovery, an injection well may be drilled and then utilized to introduce fluid into the formation. A variety of fluids may be introduced, including water, gas and chemicals. An injection pump may be part of an injection well and may include a pump shaft. The pump may be used to pressurize a fluid to enhance the recovery of hydrocarbons or to assist fluids with low mobility. The fluids around the shaft may be sealed with mechanical seals. To ensure mechanical integrity and satisfactory operation conditions, mechanical seals may be tested using a mechanical seal integrity testing rig.

Additionally, by way of general background in accordance with one or more embodiments, the American Petroleum Institute (API) standard, for example API-682, 4^{th} edition, paragraphs [10.3.5.3]-[10.3.5.4], recommends doing an integrity test (air leak test) for a refurbished or a new mechanical seal before installing it in the field, which will mitigate the possible chances of premature seal failure, avoid possible rework, and reduce the downtime of the pump. Mechanical seals of large injection pumps (e.g., mechanical pumps having shaft diameters larger than eight inches) require a large dummy shaft to cover the seal shaft area. The testing rig sleeve with a diameter of up to sixteen inches, is required to cover the seal stuffing box. These dummy shafts may be up to sixteen inches in diameter to cover the large mechanical pump shafts. As such, the mechanical seals of large injection pumps are often installed without a quality check because there are no compatible mechanical seal testing rigs due to the large diameter of the pump's shaft and the size of the stuffing box.

Thereafter, by way of general background in accordance with one or more embodiments, the top end of a mechanical seal may be understood as the inlet where the pump's shaft first interacts with the seal and the bottom end of a mechanical seal may be understood as the exit of the pump's shaft. Once the pump's shaft exits the mechanical seal, then the mechanical seal accomplishes its sealing function. For the purposes of further discussion, both the mechanical integrity testing rig and the mechanical seal have a sleeve therefore to differentiate between the two sleeves the sleeve of the mechanical seal will be referred to as “mechanical seal sleeve” and the sleeve of the mechanical seal integrity testing rig will be referred to as “testing rig sleeve”.

Additionally, by way of general background in accordance with one or more embodiments, the mechanical seal described herein is part of an injection pump however the mechanical seal may be part of various types of pumps that include, but are by no means limited to centrifugal pumps, axial flow pumps, high pressure pumps, vertical pumps and rotary gear pumps. The mechanical seal integrity testing rig proposed below may test a mechanical seal of a pump regardless of the type of the pump.

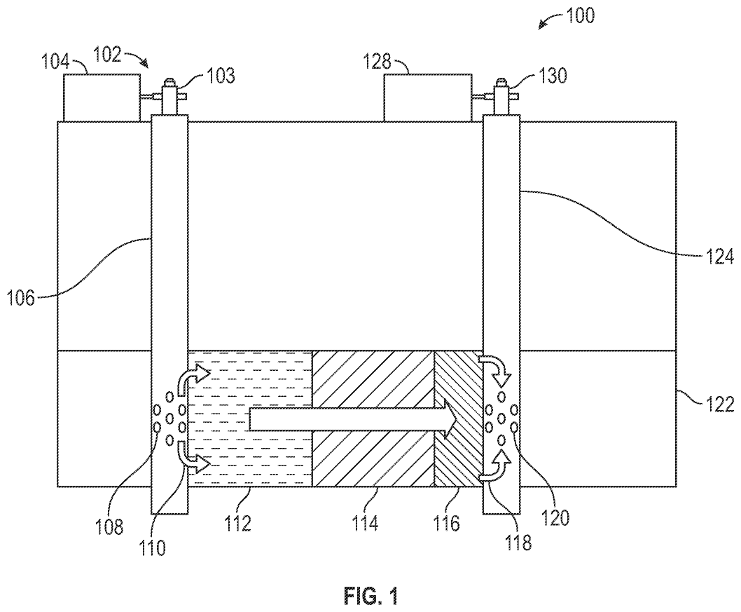

As such, FIG. 1 schematically illustrates, in cross-sectional elevational view, an injection well (102) and a production well (100) in accordance with one or more embodiments. A person skilled in the art will appreciate that the injection well (103) and production well (100) shown in FIG. 1 are for example purposes only. Any configuration of the wells and the wellsite may be used without departing from the scope of the disclosure herein. Furthermore, the wells in FIG. 1 may be located underwater, such as on the sea floor, or the wells in FIG. 1 may be located on dry land without departing from the scope of the disclosure herein.

Fluids such as water (110) are pumped using an injection pump (104) into an injection wellhead (103). The water (110) flows through the injection well casing (106) into a producing formation (122) via injection well perforations (108). In accordance with one or more embodiments, the injected water may be referred to as drive water (112) as it displaces and directs the hydrocarbons towards production well perforations (120).

Once the fluid is in the producing formation (122) and mixes effectively with the hydrocarbons, a miscible zone (114) is created. A miscible zone (114) is defined as a zone where fluids such as water (110) and hydrocarbons are able to mix uniformly and effectively to form a homogenous mixture at a molecular level which allows better displacement and extraction of hydrocarbons. The hydrocarbons and water mixture (118) is displaced through the producing formation (122) and towards the production well casing (124), where the hydrocarbons and water mixture (118) becomes concentrated in hydrocarbons and is referred to as an oil bank (116). The hydrocarbons and water mixture (118) enters the production well casing (124) and flows towards the production wellhead (130).

From the production wellhead (130), the hydrocarbons and water mixture (118) may be transported to other locations, such as a gas and oil separation plant, via surface equipment. Furthermore, other forms of assisted production may exist, such as electric-submersible pumps or pump jacks, depending on the application, without departing from the scope of the disclosure herein. In accordance with one or more embodiments, a separator (128) may be in hydraulic communication with the production wellhead (130) to separate the hydrocarbons from the water (110).

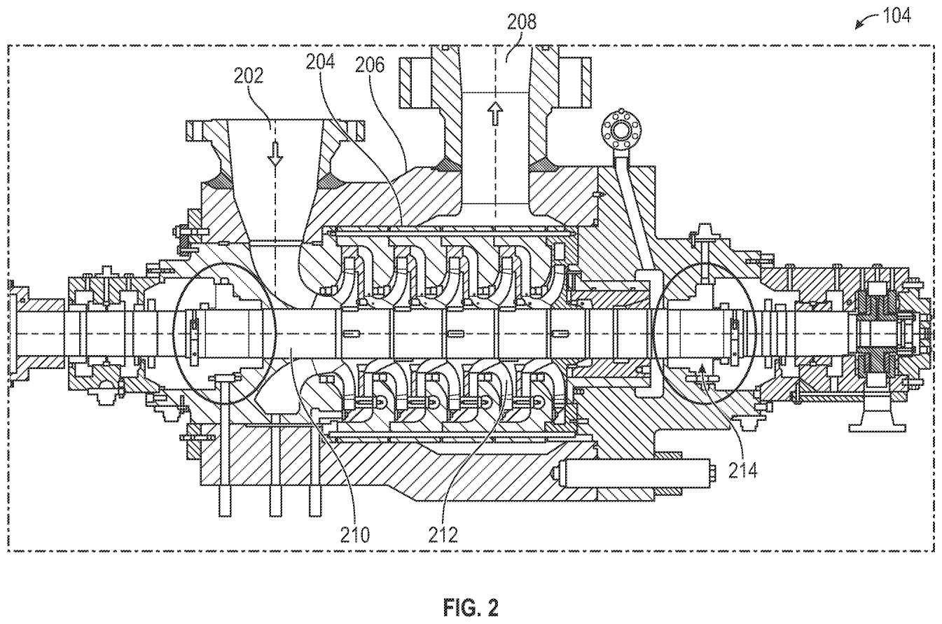

In accordance with one or more embodiments, FIG. 2 schematically illustrates a close-up, cross-sectional elevational view of the injection pump (104) of FIG. 1. The injection pump (104) is an integral part of the injection well (102) as it increases fluid pressure thereby facilitating the flow of a fluid. In accordance with one or more embodiments, the injection pump (104) may include a pump suction nozzle (202), a shaft (210), an impeller (212) and a pump exit nozzle (208). A fluid may be introduced through the pump suction nozzle (202) and towards the impellers (212). Once the shaft (210) rotates, the impellers (212) rotate as well resulting in a subsequent pressurization of the fluid. Once the fluid is pressurized, it exits the injection pump (104) through the pump exit nozzle (208). Internal components such as the impellers (212) have a protective inner casing (204) and the overall components of the pump have an outer casing (206). To avoid fluid leakage, a mechanical seal (214) is installed at each end of the shaft (210) resulting in a singular fluid exit.

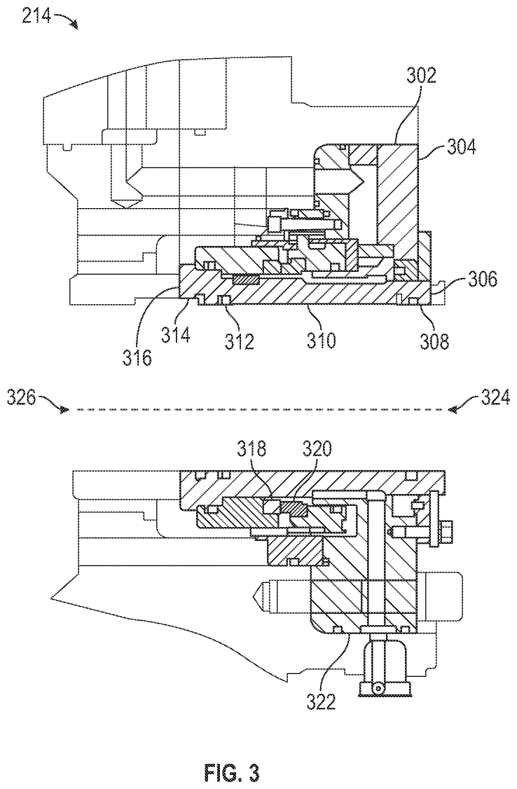

In accordance with one or more embodiments, FIG. 3 schematically illustrates a close-up, cross-sectional elevational view of the mechanical seal (214) of FIG. 2. Mechanical seals (214) are essential components of equipment associated with fluid and may be removably installed and configured to prevent leakage for a variety of equipment such as rotating equipment. In accordance with one or more embodiments, mechanical seal (214) delineates a conduit and includes a mechanical seal sleeve (310), a mechanical seal flange (304), a rotational seal face (318) and a stationary seal face (320). The mechanical seal (214) may have a top end (326) and a bottom end (324), as well as a first lateral end (302) and a second lateral end (322).

The mechanical seal sleeve (310) is a protective component that protects the shaft (210) and subsequently increases overall reliability of the injection pump (104). The mechanical seal flange (304) serves the function of a connection point to secure the mechanical seal (214). The rotational seal face (318) may have a curved surface and rotates with the shaft (210). The stationary seal face (320) is static relative to the mechanical seal (214) and in close proximity with the rotational seal face (318) to form a fluid seal. Additionally, the mechanical seal (214) includes a shaft sleeve O-ring (312) configured to be a secondary sealant.

In accordance with one or more embodiments, the rotational seal face (318) may be formed from abrasion resistant and wear resistant materials, such as Carbon, Ceramic, Nickel-resist, stainless steel 17-4, Silicon Carbide, Tungsten Carbide. The stationary seal face (320) may be formed from durable and wear resistant materials to be able to withstand operational conditions. To achieve mechanical sealing properties, a face gap created between the rotational and stationary seal faces (318, 320) which is inhabited by a fluid film. The fluid film seals the face gap to avoid any fluid leakage and forms a lubricator to enhance the mechanical seal performance.

The mechanical seal sleeve (310) may have a top end of mechanical seal sleeve (314) that includes an upper surface of top end of mechanical seal sleeve (316). Additionally, the mechanical seal sleeve (310) may have a bottom end of mechanical seal sleeve (308) that includes a lower surface of bottom end of mechanical seal sleeve (306).

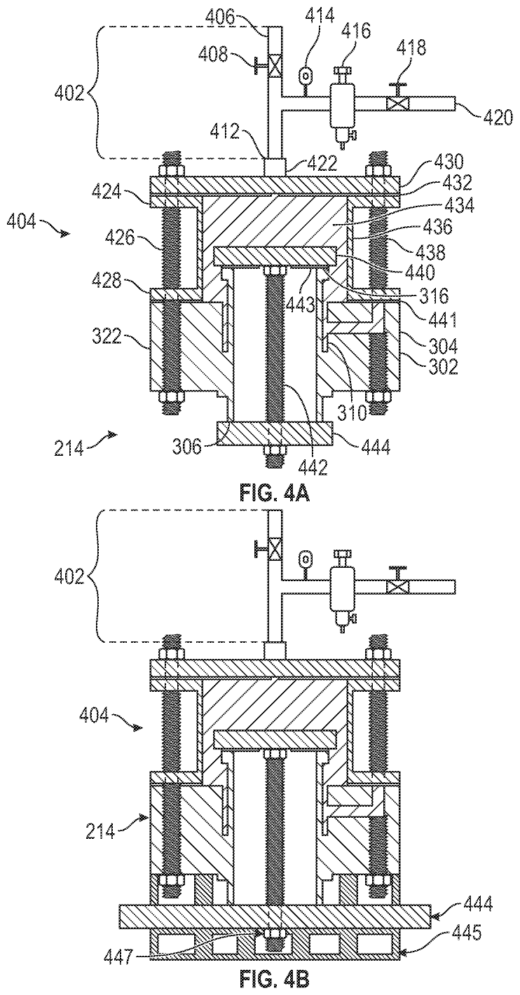

In accordance with one or more embodiments, FIG. 4A schematically illustrates a close-up, cross-sectional elevational view of the mechanical seal (214) of FIG. 2 and FIG. 3, connected to mechanical seal integrity testing rig (404). The mechanical seal integrity testing rig (404) comprises a testing rig sleeve (436) and a testing rig seal flange (430). The testing rig sleeve (436) may have a top end of testing rig sleeve (424) and a bottom end of testing rig sleeve (428). The testing rig seal flange (430) comprises a nozzle (422). The bottom end of testing rig sleeve (428) is pressed against the mechanical seal flange (304). A first fluid seal (441) is disposed between the bottom end of testing rig sleeve (428) and the mechanical seal flange (304).

The testing rig seal flange (430) is pressed against the top end of testing rig sleeve (424). A second fluid seal (432) is disposed between the testing rig seal flange (430) and the top end of testing rig sleeve (424). The testing rig seal flange (430), the testing rig sleeve (436) and the first lateral end (302) of the mechanical seal flange (304) are fastened together with a first outer stud bar (438). The testing rig seal flange (430), the testing rig sleeve (436) and the second lateral end (322) of the mechanical seal flange (304) are fastened together with a second outer stud bar (426).

In accordance with one or more embodiments, the mechanical seal integrity testing rig (404) further comprises a mechanical seal sleeve blind (440) and a clamping bar (444). The mechanical seal sleeve blind (440) is pressed against the upper surface of the top end of mechanical seal sleeve (316). A third fluid seal (443) disposed between the mechanical seal sleeve blind (440) and the upper surface of the top end of mechanical seal sleeve (316). The clamping bar (444) is pressed against the lower surface of bottom end of mechanical seal sleeve (306). An inner stud bar (442) and a clamping bar bolt (447) are used to fasten together the mechanical seal sleeve (310) and the clamping bar (444) to the mechanical seal sleeve (310). In accordance with one or more embodiments, the first fluid seal, the second fluid seal and the third fluid seal (443) may be a gasket.

In accordance with one or more embodiments, a pressure control and relief system (402) may have a tubular passageway and may be connected to the nozzle (422) of the testing rig seal flange (430). The pressure control and relief system (402) may comprise a first fluid outlet (412), a pressure gauge (414), a pressure regulator (416), a first valve (418) and a fluid inlet (420). The pressure control and relief system (402) may be connected to the nozzle via the first fluid outlet (412). The pressure gauge (414) may be fluidly connected to the mechanical seal integrity testing rig (404) and may be configured to measure an internal pressure of a fluid. The pressure regulator (416) may be fluidly connected to the pressure gauge (414) and may be configured to allow the selection of the internal pressure of a fluid. The first valve (418) may be fluidly connected to the pressure regulator (416) and configured to allow or halt the flow of a fluid towards the pressure regulator and subsequently towards the mechanical seal integrity testing rig (404). A fluid inlet (420) may allow connection of a fluid supply system (508), not pictured, that may be configured to provide a pressurized fluid to the mechanical seal integrity testing rig (404).

The pressure control and relief system (402) may additionally have a second valve (408) and second fluid outlet (406). The second valve (408) is fluidly connected to the first fluid outlet (412) and the pressure gauge (414). The second fluid outlet (406) is fluidly connected to the second valve and configured the vent out the fluid (434) of the mechanical seal integrity testing rig (404). Additionally, the pressure control and relief system (402) may comprise a filtration system that may be fluidly connected to the first valve (418) and the pressure regulator (416) and configured to filter out particles in the fluid (434). The particles in the fluid that may be filtered may include solid particles such as dust, rust and metal shavings. Such particles, if unfiltered, may damage the rotational seal face (318) and the stationary seal face, as well as potentially cause blockage of the pressure control and relief system (402).

In accordance with one or more embodiments, once the mechanical seal integrity testing rig (404) is fastened to the mechanical seal, the fluid (434) supplied by a fluid supply system (508) may flow through the pressure control and relief system (402) and into the mechanical seal integrity testing rig (404). Once the mechanical seal integrity testing rig (404) is pressurized to a selected pressure, the first valve (418) is closed, and the pressure of the fluid monitored. In accordance with one or more embodiments, the selected pressure of the mechanical seal integrity testing rig (404) may be selected based on API standards. For example, the selected pressure may be 25 pound-force per square inch (PSI), as per standard API 682, 4^{th} edition, paras. [10.3.5.3] to [10.3.5.4]. Additionally, the standard (API 682 4^{th} edition, paras. [10.3.5.3] to [10.3.5.4]) requires holding a 25 PSI pressure inside the mechanical seal integrity testing rig for 5 minutes with an allowable pressure drop of 2 PSI. A pressure drop lower than 2 PSI may be indicative of a leak which, in turn, may be indicative of a defective mechanical seal (214) that requires maintenance or replacement. Once the pre-selected test time of 5 min has passed, results are recorded, and the second valve (408) is opened to vent out the fluid (434).

In accordance with one or more embodiments, components of the mechanical seal integrity testing rig (404), such as the testing rig sleeve (436) may be 3D printed. The 3D printed components may be designed to test mechanical seals (214) of different sizes and designs. Additionally, the design of mechanical seal integrity testing rig (404) may be done to avoid obstructions.

In accordance with one or more embodiments, the pressure regulator (416) of the pressure control and relief system (402) may be a computer-controlled pressure regulator and configured to control the pressure of the fluid in the mechanical seal integrity testing rig (404). Additionally, the first valve (418) may be a computer-controlled electric actuated valve configured to control the fluid (434) from the pressure control and relief system (402) to the mechanical seal integrity testing rig (404). Also, the pressure gauge (414) of the pressure control and relief system (402) is a computer-connected pressure gauge configured to measure the pressure of the fluid (434) in the mechanical seal integrity testing rig (404).

In accordance with one or more embodiments, a pressure regulator (416) may be a computer-controlled pressure regulator (718) and a first valve (418) may be a computer-controlled first valve (720). Additionally, a pressure gauge (414) may be a computer-connected pressure gauge (716).

As such, and as will be further appreciated here below, embodiments as broadly contemplated herein provide for systems for pumping a fluid into a sub-surface formation to pressurize the sub-surface formation using an injection pump having a mechanical seal that may be tested using a mechanical seal integrity testing rig (404).

In accordance with one or more embodiments, FIG. 4B schematically illustrates an isometric view of the mechanical seal connected to a mechanical seal integrity testing rig (404) as per FIG. 4A. The mechanical seal integrity testing rig (404) is located on top of a seal holder (445) which rests on a test bench (500). The seal holder (445) may be utilized to position the clamping bar (444) and allow a mechanical seal integrity testing rig operator to access the clamping bar bolt (447). The mechanical seal (214) may be positioned over the seal holder (445) and the clamping bar (444). The seal holder (445) may be made from any durable material known in the art, such as steel. Additionally, the seal holder (445) may include a depression or an opening to allow passage of tools and bodily parts such as arms.

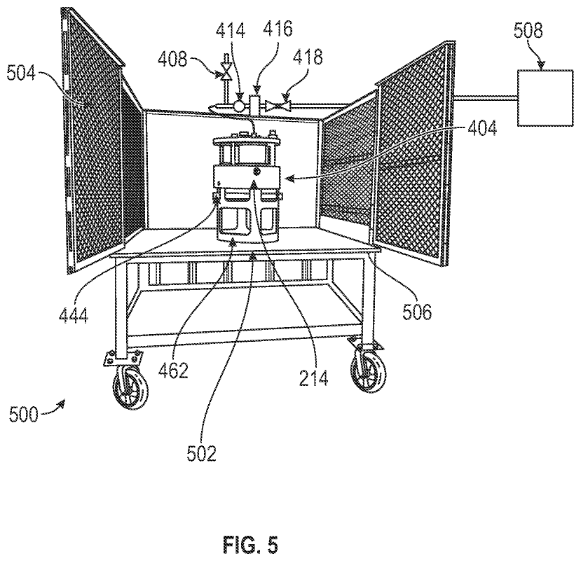

In accordance with one or more embodiments, FIG. 5 depicts a test bench (500) in accordance with one or more embodiments. The test bench (500) may be utilized to rest the mechanical seal (214) and subsequently the mechanical seal integrity testing rig (404). The test bench (500) may be portable and may be made from any durable material known in the art, such as steel. Additionally, the test bench (500) may have a raised edge (502) at a periphery (506) of the test bench (500) to contain any fluid (434) that may leak from the mechanical seal (214). Additionally, an enclosure (504) may be welded at the periphery (506) of the test bench (500) to contain any parts of the mechanical seal integrity testing rig (404) that may separate under the internal pressure of the mechanical seal integrity testing rig (404). Also, the enclosure (504) may be configured to open to have access to mechanical seal (214) and the mechanical seal integrity testing rig (404). The enclosure (504) may also be configured to close during the testing of the mechanical seal (214). The enclosure (504) may close during testing of the mechanical seal (214) to protect the operator from parts separating under pressure.

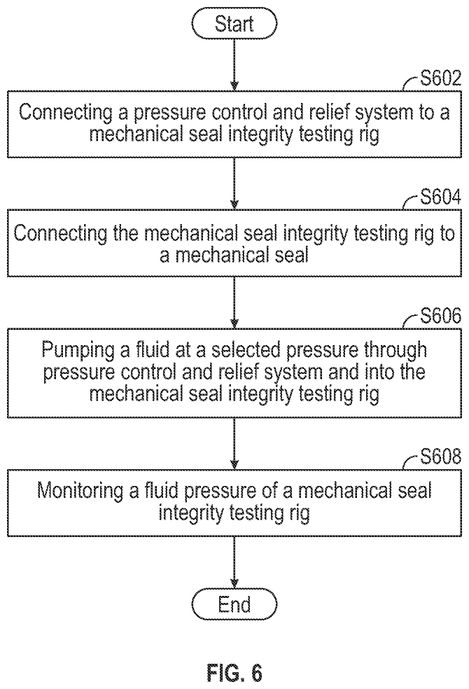

In accordance with one or more embodiments, FIG. 6 depicts a flowchart in accordance with one or more embodiments. More specifically, FIG. 6 illustrates a method for testing an integrity of a mechanical seal (214) using a mechanical seal integrity testing rig (404). Further, one or more blocks in FIG. 6 may be performed by one or more components as described in FIGS. 1-5. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Thus, in accordance with one or more embodiments, in step 602, a mechanical seal integrity testing rig (404) may be attached to a pressure control and relief system (402). Attachment of the pressure relief system (402) and the mechanical seal integrity testing rig (404) may be through a threaded connection, flanged connection or a quick connect and disconnect connection which may involve a push and twist mechanism. In step 604, a mechanical seal integrity testing rig (404) may be connected to a mechanical seal (214). In accordance with one or more embodiments, step 604 may include pressing a testing rig sleeve (436) against a mechanical seal flange (304). The mechanical seal flange (304) may have a first fluid seal between the testing rig sleeve (436) and the mechanical seal flange (304). Additionally, step 604 may include pressing a testing rig seal flange (430) against a top end of the testing rig sleeve (436). A second fluid seal (432) may be disposed between the testing rig seal flange (430) and the top end of the testing rig sleeve (436). Step 604 may additionally include fastening the testing rig sleeve (436), the testing rig seal flange (430) and the first lateral end (302) of the mechanical seal flange (304) with a first outer stud bar (438). Also, step 604 may include fastening the testing rig sleeve (436), the testing rig seal flange (430) and the second lateral end (322) of the mechanical seal (214) with a second outer stud bar (426).

In accordance with one or more embodiments, step 604 may additionally include pressuring a mechanical seal sleeve blind (440) against an upper surface of top end of the mechanical seal sleeve (310) and having a third fluid seal (443) between the mechanical seal sleeve blind (440) and the upper surface of top end of the mechanical seal sleeve (310). Also, step 604 may include pressuring a clamping bar (444) against a lower surface of bottom end of the mechanical seal sleeve (310). Step 604 may additionally include fastening the mechanical seal sleeve (310), the mechanical seal sleeve blind (440), and the clamping bar (444) with an inner stud bar (442) and a clamping bar bolt (447).

In step 606, a fluid (434) may be pumped at a selected pressure through a pressure control and relief system (402) and into a mechanical seal integrity testing rig (404). In step 608, a fluid pressure of the mechanical seal integrity testing rig (404) is monitored. The fluid pressure of the mechanical seal integrity testing rig (404) is monitored with the pressure gauge (414) of the pressure control and relief system (402). The pressure gauge (414) may have a sensing element that reacts to pressure change and may translate the pressure change into a mechanical or electrical signal.

In accordance with one or more embodiments, the method illustrated in FIG. 6 for testing an integrity of a mechanical seal (214) using a mechanical seal integrity testing rig (404) may further include closing the first valve (418) once a monitored fluid pressure is equal to the selected pressure. Additionally, the method illustrated in FIG. 6 may additionally include recording a pressure applied to the mechanical seal integrity testing rig (404) after a preselected period of time and thereafter opening the second valve (408) to depressurize the mechanical seal integrity testing rig (404). Additionally, the method illustrated in FIG. 6 may include thereafter disconnecting the mechanical seal integrity testing rig (404).

In accordance with one or more embodiments, testing a mechanical seal (214) with a mechanical seal integrity testing rig (404) (as broadly contemplated and discussed herein) offers numerous advantages that include, but are by no means limited to minimizing potential leaks from a mechanical seal (214) and subsequently avoiding a pump failure and rework, extending life of the pump by decreasing the number of pump startup where less pump failure results in longer run times which in turn requires less pump startup, ability to test large mechanical seals (214) without solely relying on the vendor's testing, and cost savings by avoiding equipment shutdown, damaged part replacement and reworks related expenses. Pump startups may reduce the life of a pump due to mechanical wear and fatigue on various components such as seals and impellers, thermal stresses and vibrations that may pump's components misalignment.

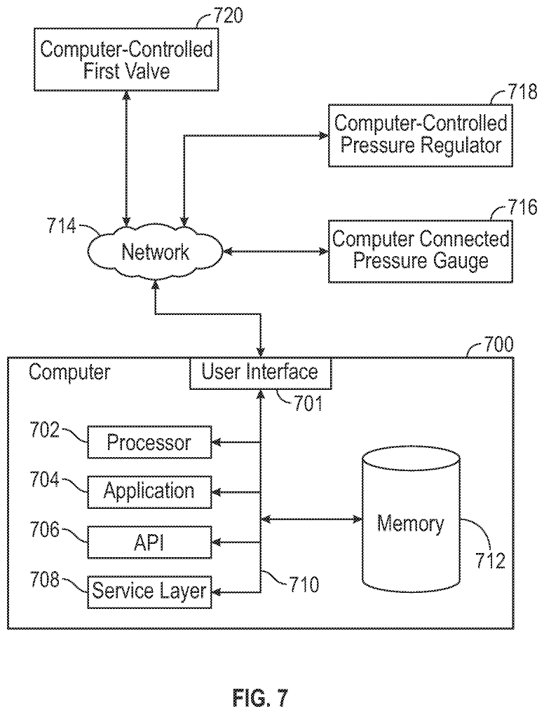

In accordance with one or more embodiments, FIG. 7 shows a computer (700) in communication with a computer connected pressure gauge (716), a computer-controlled pressure regulator (718) and a computer-controlled first valve (720). The communication may occur over a network (714) that may be a local area network using an ethernet or Wi-Fi system, or alternatively the network (714) may be a wide area network using an internet or intranet service. Alternatively, the communication may be transmitted over a network (714) using satellite communication networks.

As such, in accordance with one or more embodiments, FIG. 7 further depicts a block diagram of a computer (700) used to provide computational functionalities associated with described algorithms, methods, functions, processes, flows, and procedures as described in this disclosure, according to one or more embodiments. The illustrated computer (700) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (700) may include a computer that includes an input device, such as a keypad, keyboard, touch screen, or other device that can accept user information, and an output device that conveys information associated with the operation of the computer (700), including digital data, visual, or audio information (or a combination of information), or a GUI.

The computer (700) can serve in a role as a client, network component, a server, a database or other persistency, or any other component (or a combination of roles) of a computer system for performing the subject matter described in the instant disclosure. The illustrated computer (700) is communicably coupled with a network (714). In some implementations, one or more components of the computer (700) may be configured to operate within environments, including cloud-computing-based, local, global, or other environment (or a combination of environments).

At a high level, the computer (700) is an electronic computing device operable to receive, transmit, process, store, or manage data and information associated with the described subject matter. According to some implementations, the computer (700) may also include or be communicably coupled with an application server, e-mail server, web server, caching server, streaming data server, business intelligence (BI) server, or other server (or a combination of servers).

The computer (700) can receive requests over network (714) from a client application (for example, executing on another computer (700) and responding to the received requests by processing the said requests in an appropriate software application. In addition, requests may also be sent to the computer (700) from internal users (for example, from a command console or by other appropriate access method), external or third-parties, other automated applications, as well as any other appropriate entities, individuals, systems, or computers.

Each of the components of the computer (700) can communicate using a system bus (710). In some implementations, any or all of the components of the computer (700), both hardware or software (or a combination of hardware and software), may interface with each other or the user interface (701) (or a combination of both) over the system bus (710) using an application programming interface (API) (706) or a service layer (708) (or a combination of the API (706) and service layer (708). The API (706) may include specifications for routines, data structures, and object classes. The API (706) may be either computer-language independent or dependent and refer to a complete interface, a single function, or even a set of APIs. The service layer (708) provides software services to the computer (700) or other components (whether or not illustrated) that are communicably coupled to the computer (700). The functionality of the computer (700) may be accessible for all service consumers using this service layer. Software services, such as those provided by the service layer (708), provide reusable, defined business functionalities through a defined interface. For example, the interface may be software written in JAVA, C++, or other suitable language providing data in extensible markup language (XML) format or another suitable format. While illustrated as an integrated component of the computer (700), alternative implementations may illustrate the API (706) or the service layer (708) as stand-alone components in relation to other components of the computer (700) or other components (whether or not illustrated) that are communicably coupled to the computer (700). Moreover, any or all parts of the API (706) or the service layer (708) may be implemented as child or sub-modules of another software module, enterprise application, or hardware module without departing from the scope of this disclosure.

The computer (700) includes a user interface (701). Although illustrated as a single user interface (701) in FIG. 7, two or more user interfaces (701) may be used according to particular needs, desires, or particular implementations of the computer (700). The user interface (701) is used by the computer (700) for communicating with other systems in a distributed environment that are connected to the network (714). Generally, the user interface (701) includes logic encoded in software or hardware (or a combination of software and hardware) and operable to communicate with the network (714). More specifically, the user interface (701) may include software supporting one or more communication protocols associated with communications such that the network (714) or interface's hardware is operable to communicate physical signals within and outside of the illustrated computer (700).

The computer (700) includes at least one computer processor (702). Although illustrated as a single computer processor (702) in FIG. 7, two or more processors may be used according to particular needs, desires, or particular implementations of the computer (700). Generally, the computer processor (702) executes instructions and manipulates data to perform the operations of the computer (700) and any algorithms, methods, functions, processes, flows, and procedures as described in the instant disclosure.

The computer (700) also includes a memory (712) that holds data for the computer (700) or other components (or a combination of both) that can be connected to the network (714). For example, memory (712) can be a database storing data consistent with this disclosure. Although illustrated as a single memory (712) in FIG. 7, two or more memories may be used according to particular needs, desires, or particular implementations of the computer (700) and the described functionality. While memory (712) is illustrated as an integral component of the computer (700), in alternative implementations, memory (712) can be external to the computer (700).

The application (704) is an algorithmic software engine providing functionality according to particular needs, desires, or particular implementations of the computer (700), particularly with respect to functionality described in this disclosure. For example, application (704) can serve as one or more components, modules, applications, etc. Further, although illustrated as a single application (704), the application (704) may be implemented as multiple applications (704) on the computer (700). In addition, although illustrated as integral to the computer (700), in alternative implementations, the application (704) can be external to the computer (700).

There may be any number of computers (700) associated with, or external to, a computer system containing computer (700), wherein each computer (700) communicates over network (714). Further, the term “client,” “user,” and other appropriate terminology may be used interchangeably as appropriate without departing from the scope of this disclosure. Moreover, this disclosure contemplates that many users may use one computer (700), or that one user may use multiple computers (700).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system for pumping a fluid into a sub-surface formation to pressurize the sub-surface formation using a pump having a shaft, the system comprising:
a mechanical seal removably installed in the pump and comprising:
a mechanical seal sleeve delineating a conduit configured to receive the shaft of the pump and comprising a top end and a bottom end; and
a mechanical seal flange, comprising a first lateral end and a second lateral end; and
a mechanical seal integrity testing rig configured to be pressed against the mechanical seal and to test an integrity of the mechanical seal, the mechanical seal integrity testing rig comprising:
a testing rig sleeve having a top end of testing rig sleeve and a bottom end of testing rig sleeve, wherein the testing rig sleeve is pressed against the first lateral end and the second lateral end; and
a mechanical seal sleeve blind pressed against the top end of the mechanical seal sleeve.

2. The system of claim 1, wherein the mechanical seal integrity testing rig further comprises:
a testing rig seal flange comprising a nozzle, wherein the mechanical seal flange is pressed against the testing rig sleeve; and
a first outer stud bar configured to fasten the testing rig sleeve, the testing rig seal flange and the first lateral end of the mechanical seal.

3. The system of claim 2, further comprising a pressure control and relief system configured to connect to the nozzle of the testing rig seal flange.

4. The system of claim 3, wherein the pressure control and relief system comprises:
a fluid inlet;
a pressure regulator in fluid communication with the fluid inlet and configured to regulate a pressure of the fluid in the mechanical seal integrity testing rig;
a pressure gauge in fluid communication with the pressure regulator and configured to measure the pressure of a fluid in the mechanical seal integrity testing rig; and
a first valve that is in fluid communication with the fluid inlet and the pressure regulator and is configured to control a flow of the fluid from the pressure control and relief system to the mechanical seal integrity testing rig.

5. The system of claim 4, wherein the pressure control and relief system further comprises a filtration system in fluid communication with the first valve and the pressure regulator, wherein the filtration system is configured to filter out particles in the fluid.

6. The system of claim 4, wherein:
the pressure regulator is computer-controlled and is configured to control the pressure of the fluid in the mechanical seal integrity testing rig, and the first valve is computer-controlled.

7. The system of claim 1, further comprising a first fluid seal disposed between the testing rig sleeve and the first lateral end and second lateral end of the mechanical seal.

8. The system of claim 1, further comprises a second fluid seal disposed between the testing rig sleeve and the testing rig seal flange.

9. The system of claim 4, wherein the pressure gauge is a computer-connected pressure gauge configured to measure the pressure of the fluid in the mechanical seal integrity testing rig.

10. The system of claim 7, wherein the first fluid seal and the second fluid seal each comprise a gasket configured to contain the fluid in the mechanical seal integrity testing rig.

11. The system of claim 1, further comprising:
a clamping bar configured to be pressed against the bottom of a mechanical seal sleeve; and
an inner stud bar and a clamping bar bolt configured to fasten the mechanical seal sleeve blind and the clamping bar.

12. The system of claim 11, further comprising:
a seal holder configured to support the mechanical seal.

13. The system of claim 12, wherein the seal holder includes a depression configured to allow access to the clamping bar bolt.

14. The system of claim 12, further comprising:
a test bench having a periphery and configured to support the seal holder, the mechanical seal and the mechanical seal integrity testing rig.

15. The system of claim 14, wherein the test bench comprises a raised edge connected to the periphery and configured to contain the fluid.

16. A method for testing an integrity of a mechanical seal using a mechanical seal integrity testing rig, the method comprising:
connecting a pressure control and relief system to a mechanical seal integrity testing rig, the pressure control and relief system including a first valve and a second valve; and
connecting the mechanical seal integrity testing rig to a mechanical seal, wherein connecting the mechanical seal integrity testing rig to a mechanical seal comprises:
pressing a testing rig sleeve against a mechanical seal flange, wherein the mechanical seal flange comprises a first lateral end and a second lateral end;
pressing a testing rig seal flange against a top end of the testing rig sleeve;
fastening the testing rig sleeve, the testing rig seal flange and the first lateral end of the mechanical seal flange with a first outer stud bar; and
pressuring a mechanical seal sleeve blind against an upper surface of top end of the mechanical seal sleeve.

17. The method of claim 16, wherein connecting the mechanical seal integrity testing rig to a mechanical seal, further comprising:
pressuring a clamping bar against a lower surface of bottom end of the mechanical seal sleeve; and
fastening the mechanical seal sleeve, the mechanical seal sleeve blind, and the clamping bar with an inner stud bar.

18. The method of claim 16, further comprising:
running a fluid at a selected pressure through the pressure control and relief system and into the mechanical seal integrity testing rig;
monitoring a fluid pressure of the mechanical seal integrity testing rig; and
closing the first valve once a monitored fluid pressure is equal to the selected pressure.

19. The method of claim 18, further comprising:
recording the fluid pressure of the mechanical seal integrity testing rig after a preselected period of time and thereafter opening the second valve to depressurize the mechanical seal integrity testing rig; and
thereafter disconnecting the mechanical seal integrity testing rig.

20. The method of claim 18, wherein the pressure control and relief system further comprises a pressure regulator configured to regulate the fluid pressure.
